(19) United States
(12) Patent Application Publication
(10) Pub. No.: US 2025/0307020 A1
(43) Pub. Date: Oct. 2, 2025

(54) WORKLOAD DEPLOYMENTS USING INFRASTRUCTURE GROUPS

(71) Applicant: Hewlett Packard Enterprise Development LP, Spring, TX (US)

(72) Inventors: Divya Manoharan, Bangalore (IN); Rafiq Ahamed Kattangere, Shrewsbury, TX (US)

(21) Appl. No.: 18/746,223

(22) Filed: Jun. 18, 2024

(30) Foreign Application Priority Data
Mar. 28, 2024 (IN) 202441025188

(51) Int. Cl. G06F 9/50; G06F 9/455

(52) U.S. Cl. CPC G06F 9/505; G06F 9/45558; G06F 2009/4557

(57) ABSTRACT

In certain implementations, a method includes receiving a template request for a workload environment; obtaining an infrastructure group template corresponding to the workload environment specified in the template request; and providing, to a user device, the infrastructure group template. The user device may update the infrastructure group template to obtain an updated infrastructure group template. The method further includes receiving an infrastructure group configuration request including the updated infrastructure group template; and providing, to an infrastructure agent, an instruction to deploy an infrastructure group corresponding to the updated infrastructure group template. The infrastructure agent may initiate a deployment of the infrastructure group based on the infrastructure group template. The method further includes providing, to the user device, a status response corresponding to the deployment of the infrastructure group. The status response may indicate whether the deployment was a success or a failure.

### BACKGROUND

Computing workloads may be executed using any amount of compute resources, storage resources, network resources, or any other type of relevant resources. Such resources may be provided to entities seeking to execute such workloads. Accordingly, the resources may be configured and provided for workload execution.

### BRIEF DESCRIPTION OF THE DRAWINGS

Certain examples discussed herein will be described with reference to the accompanying drawings listed below. However, the accompanying drawings illustrate only certain aspects or implementations of examples described herein by way of example, and are not meant to limit the scope of the claims.

FIG. 1 illustrates a block diagram of an example system for providing infrastructure groups in accordance with one or more examples disclosed herein;

FIG. 2 illustrates a block diagram of an example infrastructure orchestrator in accordance with one or more examples disclosed herein;

FIG. 3 illustrates an overview of an example method 300 for configuring an infrastructure group in accordance with one or more examples disclosed herein;

FIG. 4 illustrates an example flow diagram for deploying an infrastructure group in accordance with one or more examples disclosed herein; and

FIG. 5 illustrates a block diagram of a computing device, in accordance with one or more examples disclosed herein.

The figures are drawn to illustrate various aspects of the disclosure and are not necessarily drawn to scale.

### DETAILED DESCRIPTION OF ILLUSTRATIVE EXAMPLES

The following disclosure provides many different examples for implementing different features. Specific examples of components and arrangements are described below to simplify the present disclosure. These are, of course, merely examples and are not intended to be limiting.

Infrastructure configurations using resources such as compute resources, network resources, storage resources, and the like are often used to deploy environments in which workloads may be executed. Such infrastructure configurations may, for example, be provided as-a-service (aaS), either in a cloud computing environment hosted by a cloud service provider, in a private cloud (e.g., in a data center operated by a particular entity), using a hybrid environment with aspects of both public cloud resources and private cloud resources, and/or any other environment that includes infrastructure resources. As an example, a customer may interact with a provider of Infrastructure aaS (IaaS) solutions (e.g., an infrastructure provider) to obtain resources for deploying workloads, and management services for the resources.

In one or more examples, a workload may be any set of operations, actions, processes, and the like to be performed in an IaaS environment using resources included therein. As used herein, the term workload environment encompasses various environments (e.g., virtualized computing environments, container deployments, high performance computing (HPC) clusters, and the like.) in which a workload may execute within an IaaS environment provided by and/or managed by an infrastructure provider. Thus, as an example, a customer may seek a cluster of nodes and related network and storage infrastructure in which to deploy a cluster that hosts virtual machines, containers, pods, high performance computing configurations, and/or any other form of set of resources for executing a workload, which may be referred to as a workload environment, and in which operations, actions, processes, and the like of any type may be executed, any of which may be referred to herein as a workload. Examples of workloads that may be deployed on IaaS resources include, but are not limited to: testing and development activities, high performance computing functions (e.g., complex financial, scientific, environmental, simulations), analytics (e.g., big data analytics), web applications hosting, and backup and recovery services. Workloads are not limited to the foregoing examples. However, configuring infrastructure to be provided to customers for hosting and execution of workloads may be challenging.

In order to address at least the aforementioned challenges, examples disclosed herein include techniques for configuring infrastructure resources on which workloads may be deployed. In one or more examples, a customer may request infrastructure resources for deploying workloads, such as, for example, a request for an environment in which virtual machines may be deployed, a request for an environment in which a container solution may be deployed, a request for an environment in which a HPC solution may be deployed, or any other form of workload environment. In one or more examples, such environments often have certain characteristics (e.g., amount of storage, networking configuration, number of virtual machines or containers). In one or more examples, the request may be received by an entity that provides infrastructure for such workload environments, such as, for example, an IaaS provider.

To facilitate deployment of the requested workload environment within available infrastructure of the provider, the infrastructure provider may access a set of pre-defined templates, which may correspond to various types of workload environments, and which may be referred to as infrastructure group templates. As an example, there may be one template for configuring infrastructure resources for deploying a virtualized environment in which virtual machines will be used, another template for configuring infrastructure for deploying a container solution, another template for configuring infrastructure to implement a HPC solution, and/or a template for any other workload environment.

Such templates may have a set of default parameters that may be used to configure infrastructure resources sufficient to deploy the requested workload environment. Such parameters may be adjusted based on any specific details provided in the request, and/or added or updated based on the request, such as, for example, a specific network configuration, certain amounts of storage to be available, nodes that are designed with certain capabilities (e.g., high memory, powerful accelerators, larges amount of compute resources), and/or any other relevant parameters for configuring a workload environment.

In one or more examples, the infrastructure provider that receives the request may access the set of templates available for configuring infrastructure resources, select the template that corresponds to the workload environment specified in the request (e.g., a virtualization cluster template, a container platform template, an HPC cluster template), adjust any parameters necessary to satisfy the request, and use the template to configure the infrastructure. The configured infrastructure may be referred to as an infrastructure group.

An infrastructure group, once deployed using an appropriate template, includes the compute resources, storage resources, and network resources for deploying the type of workload environment included in the request and on which workloads may be executed. An infrastructure group may include any number of nodes (e.g., computing devices), which may be homogeneous or heterogeneous, and may be configured with any number of variable configuration settings, parameters, additional services, and the like. As an example, a virtualized environment for deploying virtual machines to execute a workload may include a number of nodes, an amount of storage (e.g., local to the nodes and/or remote from and accessible by some or all of the nodes), physical network infrastructure (which may or may not be shared with other infrastructure groups), virtual network configuration, virtual storage configuration, some number of deployed virtual machines (e.g., having an operating system, various configuration settings, various services), and/or any other resources and/or configuration settings necessary to deploy the virtualized environment.

In one or more examples, a user at an infrastructure provider may, in response to a request for IaaS resources (e.g., from a customer), access a set of available templates, and select a template corresponding to an infrastructure group that includes appropriate infrastructure resources to deploy the environment included in the request. As an example, the user may send a request via a Representational State Transfer (REST) application programming interface (API) request to an infrastructure orchestrator, which may, for example, access a database that includes infrastructure group templates and return a listing of the available templates to the user. The user may select a template from among the available templates that most corresponds to the received request. Each template may be identified, for example, by a corresponding template identifier, and, optionally, a template version number.

The user may use the default settings present in the selected template (e.g., an infrastructure group for a VMware ESXi cluster has three nodes), and/or may adjust any configuration settings, parameters, resource amounts (e.g., amount of storage), resource types (e.g., type of computing devices, types of network resources, types of storage resources), and/or any other information relevant to configuring the infrastructure group for which a template parameter may be adjusted. As an example, the set of parameters for a given template may be an array of key-value pairs that may be included in a JavaScript Object Notation (JSON) file, and may include a set of default values for various parameters, which may be adjusted by a user as needed prior to sending the request to the infrastructure orchestrator. Optionally, infrastructure groups may be deployed as part of service groups (e.g., a set of infrastructure groups), where each infrastructure group may be deployed based on the same or different templates, and that may share some resources (e.g., network resources, storage resources).

In one or more examples, the infrastructure orchestrator, which may be implemented using one or more computing devices in a cloud environment and accessible over a network, may assess the request, including the template and the configuration parameters therein, to determine whether the request is for a valid configuration of an infrastructure group (e.g., perform a validation of the infrastructure group template). As an example, the infrastructure orchestrator may determine whether the template and configuration parameters call for sufficient storage to implement the requested infrastructure group. As another example, the infrastructure orchestrator may determine that the template and configuration parameters call for more resources than a customer has available. In one or more examples, if the infrastructure orchestrator determines that the requested infrastructure group is not valid, the infrastructure orchestrator may return an error to the user. The error may include one or more reasons why the infrastructure group is not valid, thereby allowing the user to adjust the template, and/or any parameters therein, in order to re-request a valid infrastructure group.

In one or more examples, once the infrastructure orchestrator determines that the template, and configuration parameters therein, represent a request for a valid infrastructure group, the infrastructure orchestrator may initiate deployment of the infrastructure group. In one or more examples, a template received as part of a request for deployment of an infrastructure group, including the configuration parameters therein, may be stored by the infrastructure orchestrator, for example, in a template database and assigned a version number or any other identifier of the template (e.g., so that the template may be added to the set of available templates and reused for future infrastructure group employments), and may serve as a blueprint for infrastructure group deployment.

In one or more examples, to deploy an infrastructure group, the infrastructure orchestrator may transmit the request (including the template and configuration parameters therein) to an infrastructure agent. In one or more examples, one of the configuration parameters included in the template is an identifier of a site at which the infrastructure group is to be deployed (e.g., a public cloud, a private cloud, a particular datacenter, and/or any other IaaS environment). In one or more examples, each such site includes at least one infrastructure agent that is in communication with the infrastructure orchestrator, which may communicate with any number of infrastructure agents at any number of sites.

In one or more examples, the infrastructure agent that receives the request to deploy an infrastructure group from the infrastructure orchestrator may convert the template and configuration parameters therein into automated operations (e.g., using Terraform, Ansible, Python, and the like) that interact with APIs available in the infrastructure environment, and/or resources therein, at the site at which the infrastructure agent is deployed to perform the provisioning and configuration of resources (e.g., nodes, storage, networking, software) that are dictated by the template received from the infrastructure orchestrator.

In one or more examples, the infrastructure agent then receives a status response indicating whether the deployment of the infrastructure group was successful. The status response may be returned to the infrastructure orchestrator, and then to the user. In one or more examples, if the deployment was not successful, reasons for the error may be included in the status response, in which case the user may take any number of actions to correct errors, and re-try the deployment. In one or more examples, if the status response indicates a successful deployment of the infrastructure group, the infrastructure group may be ready to use by the entity that initially requested deployment of the infrastructure group.

Thus, the entity that requested the infrastructure group may be provided with information related to the infrastructure group, such as, for example, information identifying the infrastructure group, the nodes (e.g., Internet Protocol (IP) addresses), virtual machines, and/or containers, as well as any information needed to begin the process of accessing the resources included in the infrastructure group so that the entity may begin to access and use the infrastructure group for executing any number of workloads (e.g., by accessing a user interface corresponding to the infrastructure group). In one or more examples, templates for successfully deployed infrastructure groups may be saved (e.g., in a database of the infrastructure orchestrator) for re-use in future infrastructure group deployments and/or so that the templates may be modified if, for example, the entity that requested the infrastructure group desires to make any changes to the infrastructure group (e.g., add resources, remove resources, change configuration parameters).

In one or more examples, the infrastructure orchestrator may also perform post-deployment functions, such as health and/or failure monitoring, lifecycle management operations, state changes, software/firmware updates, or any other management operations for the deployed infrastructure group. In one or more examples, any issues (e.g., errors, failures) that may need to be addressed may be provided to a user at the infrastructure provider, which may take any action(s) (e.g., hardware reboots, software restarts, upgrades, patches, planned maintenance) necessary to maintain the health and operation of the infrastructure group for as long as the infrastructure group may be needed.

Certain examples of this disclosure may allow for entities seeking deployment of resources in an IaaS environment to provide a request with minimal input (e.g., type of environment, amount of storage) to an infrastructure provider, which may then service the request by using pre-existing templates, and adjustments made thereto, to standardize the provisioning, frictionless deployment, availability, and seamless lifecycle management of IaaS resources to be used via deployment of infrastructure groups.

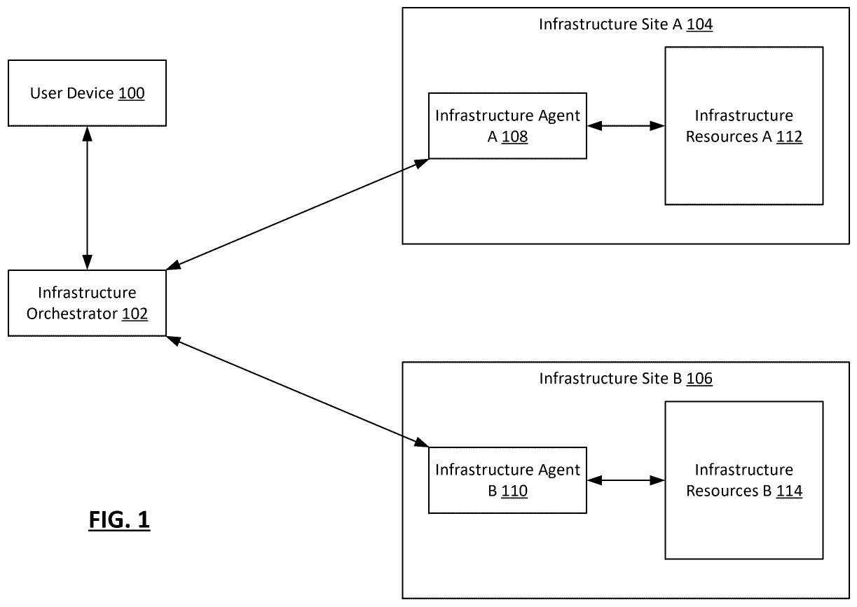

FIG. 1 illustrates a block diagram of an example system for providing infrastructure groups in accordance with one or more examples of this disclosure. The system may include a user device 100, and infrastructure orchestrator 102, an infrastructure site A 104, and an infrastructure site B 106. The infrastructure site A 104 may include an infrastructure agent A 108 and infrastructure resources A 112. The infrastructure site B may include an infrastructure agent B 110 and infrastructure resources B 114. Each of these components is described below.

In one or more examples, a user device is a computing device. In one or more examples, as used herein, a computing device, such as the user device 100, may be any single computing device, a set of computing devices, a portion of one or more computing devices, or any other physical, virtual, and/or logical grouping of computing resources.

In one or more examples, a computing device is any device, portion of a device, or any set of devices capable of electronically processing instructions and may include, but is not limited to, any of the following: one or more processors (e.g. components that include circuitry) (not shown), memory (e.g., random access memory (RAM)) (not shown), input and output device(s) (not shown), non-volatile storage hardware (e.g., solid-state drives (SSDs) (not shown), persistent memory (Pmem) devices (not shown), hard disk drives (HDDs) (not shown)), one or more physical interfaces (e.g., network ports, storage ports) (not shown), any number of other hardware components (not shown), and/or any combination thereof. As used herein, a processor may be any component that can be configured to execute operations, processes, threads, and the like. Examples of a processor include, but are not limited to, central processing units (CPUs), multi-core CPUs, application-specific integrated circuits (ASICs), accelerators (e.g., graphics processing units (GPUs)), field programmable gate arrays (FPGAs), and the like. A computing device may have any number of processors.

Examples of computing devices include, but are not limited to, a server (e.g., a blade-server in a blade-server chassis, a rack server in a rack, and the like), a desktop computer, a mobile device (e.g., laptop computer, smart phone, personal digital assistant, tablet computer, automobile computing system, and/or any other mobile computing device), a virtual machine, a virtualized computing environment, a logical container (e.g., for one or more applications), a container pod, an Internet of Things (IoT) device, an array of nodes of computing resources, a supercomputing device, a data center or any portion thereof, a collection of resources implementing a microservice-based application, and/or any other type of computing device with the aforementioned requirements.

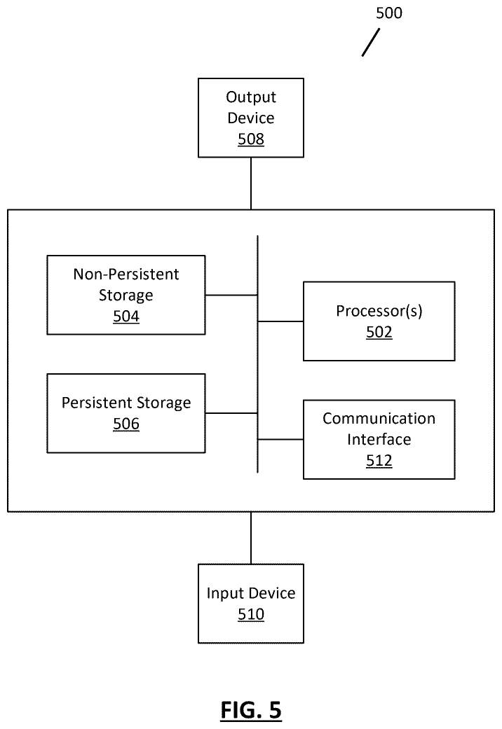

In one or more examples, any or all the aforementioned examples may be combined to create a system of such devices, or may be partitioned into separate logical devices, which may collectively be referred to as a computing device. Other types of computing devices may be used without departing from the scope of examples described herein, such as, for example, the computing device shown in FIG. 5 and described below.

In one or more examples, the storage and/or memory of a computing device or system of computing devices (e.g., the user device 100) may be and/or include one or more data repositories for storing any number of data structures storing any amount of data (e.g., information). In one or more examples, a data repository is any type of storage unit and/or device (e.g., a file system, database, collection of tables, RAM, hard disk drive, solid state drive, and/or any other storage mechanism or medium) for storing data. Further, the data repository may include multiple different storage units and/or devices. The multiple different storage units and/or devices may or may not be of the same type or located at the same physical location.

In one or more examples, any storage and/or memory of a computing device or system of computing devices, and/or network devices, may be considered, in whole or in part, as non-transitory computer readable mediums storing software and/or firmware, which, when executed by one or more processors of a computing device, cause the one or more processors to perform operations in accordance with one or more examples disclosed herein.

Such software and/or firmware may include instructions which, when executed by the one or more processors (which include circuitry) and/or other hardware (e.g., any other circuitry) of a computing device and/or system of computing devices, cause the one or more processors and/or other hardware components to perform operations in accordance with one or more examples described herein.

The software instructions may be in the form of computer readable program code to perform methods, processes, and the like of examples as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium. As an example, components such as the user device 100, the infrastructure orchestrator 102, and any of the infrastructure agents (108, 110) may include computer readable program code that includes instructions, may be stored in a non-transitory computer readable medium, and may be executed by one or more processors.

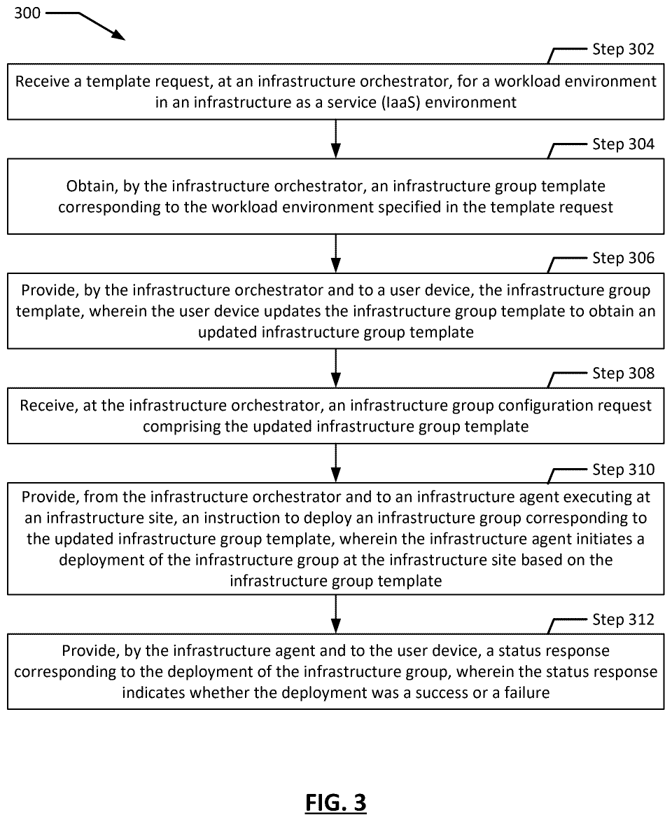

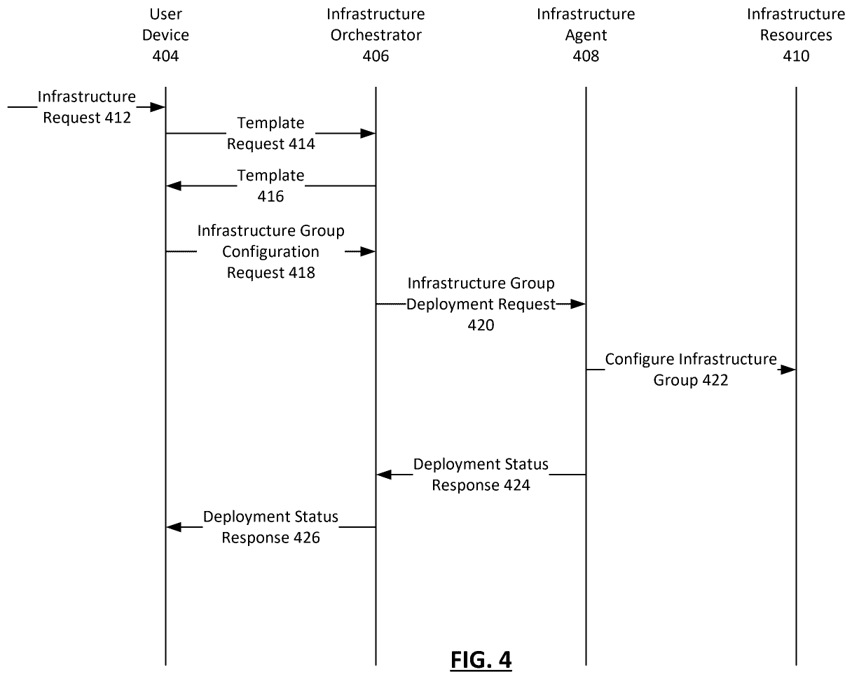

In one or more examples, the user device 100 is configured to receive requests for workload environments. As an example, the user device 100 may be used by a user at an IaaS provider, and a customer seeking infrastructure resources from the IaaS provider may transmit a request for a workload environment to the user and the user device 100. In one or more examples, any request received by the user may be provided to the user device (e.g., by the user). In one or more examples, a customer may transmit the request to the user device. Actions and operations of the user device are discussed further in the descriptions of FIG. 3 and FIG. 4, below.

Although FIG. 1 shows the system as including a single user device 100, the system may include any number of user devices without departing from the scope of examples disclosed herein.

In one or more examples, the system includes the infrastructure orchestrator 102. In one or more examples, the infrastructure orchestrator 102 is operatively connected to the user device 100. In one or more examples, the infrastructure orchestrator 102 is a computing device (described above). As an example, the infrastructure orchestrator 102 may be a service implemented on any number of nodes of a cloud environment if an IaaS provider. The infrastructure orchestrator 102 may be operatively connected to any number of user devices (e.g., the user device 100) without departing from the scope of examples disclosed herein.

In one or more examples, the infrastructure orchestrator 102 is configured to interact with any number of user devices (e.g., the user device 100) and any number of infrastructure agents (e.g., the infrastructure agent A 108, the infrastructure agent B 110, discussed below) to facilitate deployment of infrastructure groups to be used as workload environments in which workloads may be executed. In one or more examples, a workload may be any set of operations, actions, processes, and the like to be performed in an IaaS environment using resources included therein. As used herein, the term workload environment encompasses various environments (e.g., virtualized computing environments, container deployments, high performance computing (HPC) clusters) in which a workload may execute within an IaaS environment provided by and/or managed by an infrastructure provider.

Any entity seeking to execute a workload may request a workload environment, with such a request being provided to a user device (e.g., the user device 100). In one or more examples, the user device 100 may interact with the infrastructure orchestrator 102 to facilitate, at least in part, providing a workload environment in response to a request for the same. In one or more examples, the workload environment is provided as an infrastructure group. An infrastructure group may include the compute resources, storage resources, network resources, and/or any other relevant resources for deploying the type of workload environment included in the request and on which workloads may be executed. An infrastructure group may include any number of nodes (e.g., computing devices), which may be homogeneous or heterogeneous, and may be configured with any number of variable configuration settings, parameters, additional services, and the like. An infrastructure group may additionally include various network, storage, management, and other resources for implementing a workload environment.

As an example, a virtualized environment for deploying virtual machines to execute a workload may include a number of nodes, an amount of storage (e.g., local to the nodes or remote from and accessible by some or all of the nodes), physical network infrastructure (which may or may not be shared with other infrastructure groups), virtual network configuration, virtual storage configuration, some number of deployed virtual machines (e.g., having an operating system, various configuration settings), and/or any other resources and/or configuration settings necessary to deploy the virtualized environment.

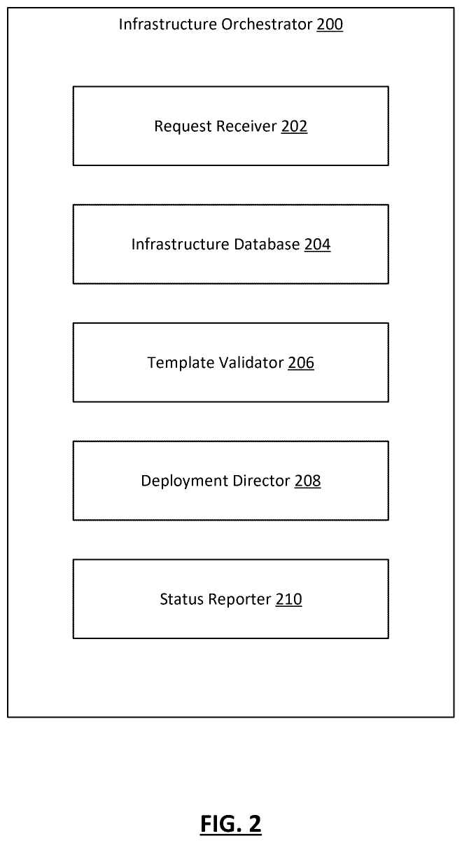

In one or more examples, the infrastructure orchestrator 102 interacts with the user device 100 and one or more infrastructure agents (e.g., the infrastructure agent A 108, the infrastructure agent B 110) to provide infrastructure groups for use as workload environments. The infrastructure orchestrator 102 is discussed further in the description of FIG. 2, below. The configuration of infrastructure groups for use as workload environments is discussed further in the descriptions of FIG. 3 and FIG. 4, below.

Although FIG. 1 shows the system as including a single infrastructure orchestrator 102, the system may include any number of infrastructure orchestrators without departing from the scope of examples disclosed herein.

In one or more examples, the system includes any number of infrastructure sites, such as the infrastructure site A 104 and the infrastructure site B 106. In one or more examples, an infrastructure site (e.g., 104, 106) is a collection of resources (e.g., compute resources, storage resources, network resources, management resources, other resources) of an IaaS provider for providing IaaS resources (e.g., to entities seeking IaaS). An infrastructure site (e.g., 104, 106) may be a collection of resources at the same physical location (e.g., a single datacenter), and/or may be a collection of resources at different physical locations that are logically grouped together to form an infrastructure site.

Although FIG. 1 shows the system as including two infrastructure sites (infrastructure site A 104, infrastructure site B 106), the system may include any number of infrastructure sites without departing from the scope of examples disclosed herein.

In one or more examples, an infrastructure site (e.g., 104, 106) includes at least one infrastructure agent (e.g., the infrastructure agent A 108 of the infrastructure site A 104, the infrastructure agent B 110 of the infrastructure site B 106). In one or more examples, the infrastructure agent (e.g., 108, 110) is any hardware, software, firmware, or any combination thereof configured to interact with the infrastructure orchestrator 102 to configured infrastructure groups at an infrastructure site (e.g., 104, 106). As an example, an infrastructure agent (e.g., 108, 110) may execute using all or any portion of a computing device (described above) operatively connected to and/or at an infrastructure site (e.g., 104, 106).

In one or more examples, an infrastructure agent (e.g., 108, 110) is configured to interact with the infrastructure orchestrator 102 to receive instructions related to configuring an infrastructure group to be used as a workload environment. In one or more examples, details regarding an infrastructure group to be configured are received at an infrastructure agent (e.g., 108, 110) from the infrastructure orchestrator 102. In one or more examples, the infrastructure agent (e.g., 108, 110) then uses the details received from the infrastructure orchestrator 102 to interact with resources (e.g., compute resources, storage resources, compute resources, discussed below) of the infrastructure site (e.g., 104, 106) to configure an infrastructure group. An infrastructure agent (e.g., 108, 110) may use any one or more tools, interfaces, techniques, (e.g., Terraform, Ansible, Python, Puppet, Chef, CloudFormation, any other tools for configuring infrastructure) and the like to interact, directly or indirectly, with the various resources to configure an infrastructure group.

Although FIG. 1 shows the system as having infrastructure sites (e.g., 104, 106) each having a single infrastructure agent (e.g., 108, 110, respectively), an infrastructure site may have any number of infrastructure agents without departing from the scope of examples disclosed herein. Additionally, any infrastructure agent (e.g., 108, 110) may be operatively connected to and configured to interact with resources of more than one infrastructure site without departing from the scope of examples disclosed herein.

In one or more examples, an infrastructure site (e.g., 104, 106) may include any amount of infrastructure resources (e.g., the infrastructure resources A 112 of the infrastructure site A 104, the infrastructure resources B 114 of the infrastructure site B 106) of various types, such as compute resources, storage resources, management resources, and the like.

In one or more examples, compute resources include computing devices of any types (e.g., nodes), such as computing devices as described above. Infrastructure resources (e.g., 112, 114) may include any number of computing devices, all or any portion of which may be heterogeneous or homogenous, without departing from the scope of examples disclosed herein. Any amount of compute resources (e.g., any number of computing device nodes) may be used to configure an infrastructure group without departing from the scope of examples disclosed herein. As an example, an infrastructure group for deploying a container platform in which a workload may be executed may include ten compute nodes with various configurations of processors, accelerators, storage, memory, and the like. In one or more examples, compute resources are exclusive to a particular infrastructure group. Additionally, or alternatively, compute resources may be shared between infrastructure groups.

In one or more examples, storage resources may include storage devices of any type, which may be included in and/or operatively connected to any of the compute resources of the infrastructure resources (e.g., 112, 114). Examples of storage devices include, but are not limited to a disk drive array, a fibre channel storage device, an Internet Small Computer Systems Interface (ISCSI) storage device, a tape storage device, a flash storage array, a network attached storage (NAS) device, a persistent memory device, a shared memory device, or any other type of device capable of storing information. Any amount of storage resources (e.g., any number of storage devices of the same or different types) may be used to configure an infrastructure group without departing from the scope of examples disclosed herein. In one or more examples, storage resources are exclusive to a particular infrastructure group. Additionally, or alternatively, storage resources may be shared between infrastructure groups.

In one or more examples, network resources may include network devices and components of any type, which may be included in and/or operatively connected to any of the compute resources of the infrastructure resources (e.g., 112, 114). Examples of network devices and components include, but are not limited to switches, routers, multi-layer switches, network interface cards (NICs), SmartNICs InfiniBand devices, and the like. In one or more examples, network resources may be used for transmitting network data units (e.g., packets, frames, and the like) among devices included in and/or operatively connected to a network. A network may refer to an entire network or any portion thereof (e.g., a logical portion of the devices within a topology of devices). A network may include a datacenter network, a wide area network, a local area network, a wireless network, a cellular phone network, an InfiniBand network, and/or any other suitable network that facilitates the exchange of information from one part of the network to another. A network may be a combination of any of the aforementioned network types. A network may be located at a single physical location (e.g., a particular infrastructure site (e.g., 104, 106)) or be distributed at any number of physical sites. In one or more examples, a network may be coupled with or overlap with, at least in part, the Internet.

In one or more examples, infrastructure resources (e.g., 112, 114) may include any other types of resources without departing from the scope of examples disclosed herein. As an example, infrastructure resources (e.g., 112, 114) may include any number of computing devices (described above) that may be configured to manage, at least in part, all or any portion of the infrastructure resources (e.g., 112, 114), such as controllers, management consoles, container management devices, various types of management software, and the like.

While FIG. 1 shows a particular configuration of components, other configurations may be used without departing from the scope of examples described herein. For example, although FIG. 1 shows certain components as part of the same or separate devices, any of the components may be grouped in sets of one or more components which may exist and execute as part of any number of separate and operatively connected devices. As another example, a single component may be configured to perform all, or any portion of the functionality performed by the all or any portion of the components shown in FIG. 1. As another example, for the sake of clarity, only certain components of the system are shown. However, the system may include any number of additional components without departing from the scope of examples disclosed herein. Accordingly, examples disclosed herein should not be limited to the configuration of components shown in FIG. 1.

FIG. 2 illustrates a block diagram of an example infrastructure orchestrator in accordance with one or more examples disclosed herein. As shown in FIG. 2, the infrastructure orchestrator 200 includes a request receiver 202, an infrastructure database 204, a template validator 206, a deployment director 208, and a status reporter 210. Each of these components is described below.

In one or more examples, the infrastructure orchestrator 200 may be the same as or similar to the infrastructure orchestrator 102 shown in FIG. 1 and described above. As such, for example, the infrastructure orchestrator may be implemented using any one or more computing devices, and be configured to interact with any number of user devices (e.g., the user device 100 of FIG. 1) and any number of infrastructure agents (e.g., the infrastructure agent A 108 and the infrastructure agent B 110 of FIG. 1) to configured infrastructure groups for executing workloads.

In one or more examples, the infrastructure orchestrator 200 includes the request receiver 202. The request receiver 202 may be any hardware, software, firmware, or any combination thereof, that is configured to receive requests related to configuring infrastructure groups to be used as workload environments in which one or more workloads may be executed. Any type of request may be received by the request receiver without departing from the scope of examples disclosed herein. As an example, such a request may be received from a user device (e.g., the user device 100 of FIG. 1) over a network.

In one or more examples, one type of request that may be received by the request receiver 202 is a request to obtain one or more infrastructure group templates. As an example, a user device may send a Get request using a REST API implemented by the infrastructure orchestrator 200 (e.g., /rest/v1/template(GET)) to the infrastructure orchestrator to obtain the one or more infrastructure group templates. In one or more examples, the infrastructure orchestrator 200, in response to a request for one or more infrastructure group templates, may access a set of infrastructure group templates stored in an infrastructure database 204 (described below) to obtain the one or more infrastructure group templates with which to respond to the template request.

In one or more examples, an infrastructure group template is a pre-defined template, which may correspond to any one of various types of workload environments. As an example, there may be one template for configuring an infrastructure group for deploying a virtualized environment in which virtual machines will be used, another template for configuring infrastructure for deploying a container solution, another template for configuring infrastructure to implement a HPC solution, and/or a template for configuring any other set of resources to be used as an infrastructure group for a workload environment.

In one or more examples, an infrastructure group template may have a set of default parameters that may be used to configure infrastructure resources sufficient to deploy the requested workload environment as an infrastructure group. In one or more examples, the infrastructure orchestrator 200 may return one or more templates to a user device (e.g., the user device 100 of FIG. 1) in response to the template request.

In one or more examples, the request receiver receives requests for configuring an infrastructure group after one or more templates are provided in response to the template request. In one or more examples, the infrastructure group is intended to be used by an entity that made an initial request to a user device as a workload environment in which to execute one or more workloads.

In one or more examples, the initial request to the user device may include a minimal amount of information, such as, for example, a type of workload environment (e.g., a virtualization environment, a container environment, a HPC environment, and the like) and an amount of storage. However, a request received by the request receiver 202 to configure an infrastructure group, although based on the initial request from the entity seeking a workload environment, may include a variety of additional information, including, but not limited to: a number of nodes (e.g., computing devices); configuration details for the nodes to be included in the infrastructure group (e.g., number of processors, number of GPUs, amount of memory, network capabilities, local storage amount, operating systems for the nodes, number of virtual machines deployed on the nodes, number of containers deployed on the nodes, configuration settings for the nodes, and/or any other configuration information); configuration details related to networking configuration for the infrastructure group (e.g., network architecture within the infrastructure group, network connections to devices external to the infrastructure group, virtual network configuration, and/or any other relevant network configurations); configuration details related to storage of the infrastructure group (e.g., configuration of local node storage, configuration of any remote storage, redundancy configuration, backup/restore configuration, and/or any other relevant storage configuration); services available in the infrastructure site where the infrastructure group is being deployed that are to be provided for the infrastructure group (e.g., domain name server (DNS) service, network time protocol (NTP) service, dynamic host configuration protocol (DHCP) services, static Internet Protocol (IP) address services, and/or any other relevant services); and/or any other configuration details relevant to deploying a set of resources as an infrastructure group to be used as a workload environment in which one or more workloads will execute.

In one or more examples, the request receiver 202 is configured to receive requests for configuring an infrastructure group using a REST API. As an example, a user device (e.g., the user device 100 of FIG. 1) may transmit the request in a form that utilizes a REST API implemented by the infrastructure orchestrator 200. The request may include the configuration details and a command to apply the configuration details to deploy an infrastructure group. In one or more examples, the configuration details are included in an infrastructure group template provided as part of the request.

In one or more examples, an infrastructure group template included in the request is based on an infrastructure group template provided to the user device by the infrastructure orchestrator 200 in response to a template request. The infrastructure group template included in the configuration request may be the same as an infrastructure group template provided to the user device (e.g., including the default configuration details of the infrastructure group template), or may have all or any portion of the aforementioned configuration details modified from the default settings of the infrastructure group template. In one or more examples, the infrastructure group template also includes an identifier of an infrastructure site (e.g., the infrastructure site A 104, the infrastructure site B 106 of FIG. 1).

Such configuration details included in the infrastructure group template used in the infrastructure group configuration request may be adjusted based on any specific details relevant to deploying an infrastructure group that will satisfy the initial request for a workload environment, such as, for example, a specific network configuration, certain amounts of storage to be available, nodes that are designed with certain capabilities (e.g., high memory, powerful accelerators, larges amount of compute resources, and the like), and/or any other relevant configuration details.

In one or more examples, the infrastructure orchestrator 200 includes the infrastructure database 204. In one or more examples, the infrastructure database 204 is a data structure of any type implemented using any number of storage devices of any type(s) that is configured to store any information related to deployment of infrastructure groups. As an example, as discussed above, the infrastructure database 204 may include any number of pre-defined infrastructure group templates to be used as the basis for infrastructure group configuration requests. As another example, the infrastructure database 204 may be used to store additional infrastructure group templates that have been used to successfully deploy one or more infrastructure groups. The infrastructure database 204 may include any other relevant information without departing from the scope of examples included herein.

In one or more examples, the infrastructure orchestrator 200 includes the template validator 206. In one or more examples, the template validator 206 may be any hardware, software, firmware, or any combination thereof, that is configured to perform validation of an infrastructure group template included in a request received by the request receiver 202 to configure an infrastructure group. In one or more examples, validating an infrastructure group template includes performing a check of the configuration details therein to determine whether the infrastructure group template, if used to deploy an infrastructure group, would result in a valid configuration for an infrastructure group. As an example, the template validator 206 may determine whether an infrastructure group template and configuration parameters call for sufficient storage to implement the requested infrastructure group. As another example, the template validator 206 may determine that the infrastructure group template and configuration parameters call for more resources than a customer has available. In one or more examples, if the template validator 206 determines that the requested infrastructure group is not valid, the template validator 206 may return an error, which may be provided to a user via a user device (e.g., the user device 100 of FIG. 1). The error may include one or more reasons why the infrastructure group template is not valid, thereby allowing the user to adjust the infrastructure group template, and/or any configuration details therein, in order to re-request a valid infrastructure group. In one or more examples, once the template validator 206 determines that the template, and configuration parameters therein, represent a request for a valid infrastructure group, the infrastructure orchestrator 200 may initiate deployment of the infrastructure group.

In one or more examples, an infrastructure group template that is determined to be valid by the template validator 206 may be stored in the infrastructure database 204 for future use in deploying infrastructure groups. Thus, an infrastructure group template may include any amount of identifying information that allows the infrastructure group template to be identified and accessed from the infrastructure database 204, such as, for example, a template identifier, a template version identifier, and the like. As an example, a template identifier may correspond to a particular type of workload environment (e.g., a container platform environment), and a version number may uniquely identify an infrastructure group template from among templates having such a template identifier and corresponding to the type of workload environment.

In one or more examples, the infrastructure orchestrator 200 includes the deployment director 208. In one or more examples, the deployment director 208 may be any hardware, software, firmware, or any combination thereof, that is configured to interact with any number of infrastructure agents (e.g., the infrastructure agent A 108 and the infrastructure agent B 110 of FIG. 1) to deploy infrastructure groups based on configuration details included in infrastructure group templates received as part of a request to deploy an infrastructure group. In one or more examples, the deployment director 208 interacts with the infrastructure agents using any appropriate infrastructure deployment techniques, languages, commands, and the like (e.g., Terraform, Ansible, Python, and the like). In one or more examples, the deployment director 208 provides the configuration details of the infrastructure group to be deployed to an infrastructure agent at an infrastructure site where the infrastructure group is to be deployed.

In one or more examples, the infrastructure orchestrator 200 includes the status reporter 210. In one or more examples, the status reporter 210 may be any hardware, software, firmware, or any combination thereof, that is configured to receive and/or transmit any status reports related to infrastructure group deployment. As an example, the status reporter 210 may be configured to transmit infrastructure group template validation results from the template validator 206 to a user device. As another example, the status reporter 210 may be configured to receive status reports regarding whether deployment of an infrastructure group was or was not successful from an infrastructure agent. As another example, the status reporter 210 may be configured to propagate status reports regarding the success or failure of an infrastructure group deployment (e.g., based on a status report received from an infrastructure agent) to a user device.

While FIG. 2 shows a particular configuration of components, other configurations may be used without departing from the scope of examples described herein. For example, although FIG. 1 shows certain components as part of the same or separate devices, any of the components may be grouped in sets of one or more components which may exist and execute as part of any number of separate and operatively connected devices. As another example, a single component may be configured to perform all, or any portion of the functionality performed by the all or any portion of the components shown in FIG. 2. As another example, for the sake of clarity, only certain components of the system are shown. However, the system may include any number of additional components, and/or additional instances of components that are shown in FIG. 2, without departing from the scope of examples disclosed herein. Accordingly, examples disclosed herein should not be limited to the configuration of components shown in FIG. 2.

FIG. 3 illustrates an overview of an example method 300 for configuring an infrastructure group in accordance with one or more examples disclosed herein. All or any Step of the method 300 may be performed, in whole or in part, by one or more components of the system shown in FIG. 1 (e.g., the infrastructure orchestrator 102) and/or FIG. 2 (e.g., the infrastructure orchestrator 200 and any component therein).

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel with other steps of FIG. 3.

In Step 302, the method 300 includes receiving a template request, at an infrastructure orchestrator (e.g., the infrastructure orchestrator 102 of FIG. 1, the infrastructure orchestrator 200 of FIG. 2), for a workload environment in an infrastructure as a service (IaaS) environment. In one or more examples, the template request may be received from a user device (e.g., the user device 100 of FIG. 1). In one or more examples, the request may be received by a request receiver (e.g., the request receiver 202 of FIG. 2). In one or more examples, the template request is based, at least in part, on an initial request for a workload environment provided to the user device from an entity seeking a workload environment in which to execute one or more workloads. In one or more examples, the template request specifies a type of workload environment (e.g., a virtualization environment for virtual machines, a container environment for deploying containers, a HPC environment for executing HPC workloads). The template request may include any other information without departing from the scope of examples disclosed herein. As an example, the template request may be received from a user device at the infrastructure orchestrator via a network as a REST API command.

In Step 304, the method 300 includes obtaining, by the infrastructure orchestrator (e.g., the infrastructure orchestrator 102 of FIG. 1, the infrastructure orchestrator 200 of FIG. 2), an infrastructure group template corresponding to the workload environment specified in the template request. As an example, the infrastructure group template may be obtained by the infrastructure orchestrator from an infrastructure database (e.g., the infrastructure database 204 of FIG. 2) of the infrastructure orchestrator. In one or more examples, the infrastructure database includes any number of infrastructure group templates each corresponding to a type of workload environment. There may be any number of infrastructure group templates for different configurations of infrastructure groups corresponding to a particular type of workload environment.

In Step 306, the method 300 includes providing, by the infrastructure orchestrator (e.g., the infrastructure orchestrator 102 of FIG. 1, the infrastructure orchestrator 200 of FIG. 2) and to a user device (e.g., the user device 100 of FIG. 1), the infrastructure group template, wherein the user device updates the infrastructure group template to obtain an updated infrastructure group template. In one or more examples, the infrastructure group template includes default configuration details (configuration details are discussed further in the descriptions of FIG. 1 and FIG. 2, above) for an infrastructure group, such as configuration details related to compute resources, storage resources, network resources, management resources, services, and the like of an infrastructure group. In one or more examples, a user of the user device may modify all or any portion of the default configuration details to generate the updated infrastructure group template.

In Step 308, the method 300 includes receiving, at the infrastructure orchestrator (e.g., the infrastructure orchestrator 102 of FIG. 1, the infrastructure orchestrator 200 of FIG. 2), an infrastructure group configuration request comprising the updated infrastructure group template. As an example, the infrastructure group configuration request may be received from the user device via a network as part of a REST API command that includes the infrastructure group template (including the configuration details therein) and an instruction to apply the infrastructure group template to deploy an infrastructure group template to be used as a workload environment for executing one or more workloads.

In one or more examples, although not shown in FIG. 3, prior to performing any actions to deploy an infrastructure group based on the updated infrastructure group template, the infrastructure orchestrator may perform a validation (e.g., using the template validator 206 of FIG. 2) of the updated infrastructure group template to determine if the configuration details therein are likely to result in a successful infrastructure group deployment. In one or more examples, such a validation may avoid using resources and/or time to attempt to deploy an invalid infrastructure group. Any aspect of the configuration details included in the updated infrastructure group template may be assessed as part of the validation. Examples include, but are not limited to, validating the intended network configuration, validating the intended storage configuration, validating that the entity seeking deployment of the workload environment has contracted for sufficient infrastructure resources to deploy the infrastructure group, and/or validating any other aspect of the configuration details of the updated infrastructure group template. In one or more examples, if the validation is successful, the method 300 may proceed to Step 310. However, if the validation is not successful, the infrastructure orchestrator may provide an indication of the failed validation to the user device, which may include one or more reasons for the validation failure. In one or more examples, providing an indication of the validation failure may allow a user of the user device to assess the reasons for the validation failure, further update the infrastructure group template, and provide the further updated infrastructure group template to the infrastructure orchestrator (e.g., restart at Step 302).

In Step 310, the method 300 includes providing, from the infrastructure orchestrator (e.g., the infrastructure orchestrator 102 of FIG. 1, the infrastructure orchestrator 200 of FIG. 2) and to an infrastructure agent (e.g., the infrastructure agent 108 or the infrastructure agent 110 of FIG. 1) executing at an infrastructure site (e.g., the infrastructure site 104 or the infrastructure site 106 of FIG. 1), an instruction to deploy an infrastructure group corresponding to the updated infrastructure group template. In one or more examples, the infrastructure agent initiates a deployment of the infrastructure group at the infrastructure site based at least in part on the infrastructure group template, and specifically the configuration details therein. As an example, the infrastructure agent may use infrastructure deployment techniques and languages (e.g., Terraform, Ansible, Python, and the like) to interact with infrastructure resources (e.g., the infrastructure resources A 112 or the infrastructure resources 114 of FIG. 1), or any other components of an infrastructure site, to deploy an infrastructure group based on the configuration details of the updated infrastructure group template.

In Step 312, the method 300 includes providing, by the infrastructure orchestrator (e.g., the infrastructure orchestrator 102 of FIG. 1, the infrastructure orchestrator 200 of FIG. 2) and to the user device (e.g., the user device 100 of FIG. 1), a status response corresponding to the deployment of the infrastructure group, wherein the status response indicates whether the deployment was a success or a failure. In one or more examples, the infrastructure agent that deployed the infrastructure group using resources of an infrastructure site and based on the updated infrastructure group template determines whether or not the deployment of the infrastructure group was a success or a failure. In one or more examples, the infrastructure agent provides a status response to the infrastructure orchestrator indicating the success or failure, and, optionally one or more reasons in the case of a failure. In one or more examples, the infrastructure orchestrator then provides a status response to the user device from which the infrastructure group configuration request was received based on the status response from the infrastructure agent (e.g., indicating success or failure of the infrastructure group deployment).

In one or more examples, although not shown in FIG. 3, a user of the user device that receives an indication of a failed deployment of an infrastructure group may assess the reasons for the failure, and update the infrastructure group template to address the reasons for failure. The updated infrastructure group template may then be provided to the infrastructure orchestrator to re-attempt deployment of the infrastructure group (e.g., return to Step 302).

In one or more examples, although not shown in FIG. 3, once an infrastructure group has been successfully deployed, the infrastructure orchestrator and/or the user device may provide various details regarding the infrastructure group to the entity seeking to execute one or more workloads using the infrastructure group. Such details may include, but are not limited to, information identifying the infrastructure group, the nodes (e.g., Internet Protocol (IP) addresses), virtual machines, containers, and the like, as well as any information needed to begin the process of accessing the resources included in the infrastructure group so that the entity may begin to access and use the infrastructure group for executing any number of workloads (e.g., by accessing a user interface corresponding to the infrastructure group). In one or more examples, templates for successfully deployed infrastructure groups may be saved (e.g., in the infrastructure database 204 of FIG. 2) for re-use in future infrastructure group deployments and/or so that the templates may be modified if, for example, the entity that requested the infrastructure group desires to make any changes to the infrastructure group (e.g., add resources, remove resources, change configuration parameters).

Additionally, the infrastructure orchestrator may then provide a variety of post-deployment services for the infrastructure group, including, but not limited to, health and/or failure monitoring, lifecycle management operations, state changes, software/firmware updates, and the like. In one or more examples, any issues (e.g., errors, failures) that may need to be addressed may be provided to a user at the infrastructure provider, which may take any action(s) (e.g., hardware reboots, software restarts, upgrades, patches, planned maintenance) necessary to maintain the health and operation of the infrastructure group for as long as it may be needed.

FIG. 4 illustrates an example flow diagram for deploying an infrastructure group in accordance with one or more examples disclosed herein. The example shown in FIG. 4 and discussed below is a simplified example intended for explanatory purposes only, and not intended to limit the scope of examples described herein. Additionally, while the example of FIG. 4 shows certain aspects of examples described herein, all possible aspects of such examples may not be illustrated in this particular example. One of ordinary skill in the art will appreciate that any of the components of the example shown in FIG. 4 may be the same as, or combined with, similarly named and/or numbered components in any other figure, such as, for example, FIG. 1 and/or FIG. 2.

Consider a scenario in which an entity has engaged an IaaS provider to have access to a set of infrastructure resources, and seeks to use the resources to deploy virtualization environment as a workload environment for deploying a number of virtual machines. In such a scenario, the entity may send an infrastructure request 412 to a user device 404 of the infrastructure provider. The request may be relatively simple, and specify only that the entity is seeking a virtualization environment with a certain amount of remote storage available to the virtual machines to be deployed therein.

In response to the infrastructure request 412, the user device 404 may provide a template request 414 to an infrastructure orchestrator 406. The template may, for example, be a REST API get request.

In response to the template request 414, the infrastructure orchestrator 406 may access an infrastructure database that includes a number of infrastructure group templates for a variety of possible workload environments, including at least one infrastructure group template for a virtualization environment.

The infrastructure orchestrator 406 may return the infrastructure group template 416 for a virtualization environment to the user device 404. A user of the user device 404 may assess the infrastructure group template and the default configuration details included therein. The user may modify the configuration details based on knowledge of the particular virtualization environment that the entity seeking the workload environment requires, such as, for example, specifying a number of nodes, a number of virtual machines and details related thereto (e.g., operating system type), particular network configuration details, and storage information to facilitate provisioning the storage requested as part of the infrastructure request 412.

The user device 404 may then provide an infrastructure group configuration request 418 to the infrastructure orchestrator 406. The infrastructure group configuration request 418 may, for example, be a REST API command that includes the updated infrastructure group template and an instruction to apply the template to deploy an infrastructure group based in the infrastructure group template.

The infrastructure orchestrator 406 may assess the infrastructure group template received as part of the infrastructure group configuration request 418 to perform a validation that determines that the infrastructure group template is likely to result in a successful infrastructure group deployment.

After the successful validation, the infrastructure orchestrator 406 may provide an infrastructure group deployment request to an infrastructure agent at an infrastructure site, which was specified as part of the infrastructure group template.

The infrastructure agent 408 may then configure an infrastructure group 422 based on the infrastructure group template by using Terraform or the like to configure infrastructure resources 410 to deploy the infrastructure group.

The infrastructure agent 408 may then determine that the deployment of the infrastructure group was successful, and provide a deployment status response 424 to the infrastructure orchestrator 406. The infrastructure orchestrator 406 may then provide a deployment status response to the user device indicating a successful infrastructure group deployment. At this point, the infrastructure group is ready to be used by the entity that requested the virtualization environment to being workload execution.

FIG. 5 illustrates a block diagram of a computing device, in accordance with one or more examples of this disclosure. As discussed above, examples described herein may be implemented using computing devices. For example, the all or any portion of the components shown in FIG. 1 and/or FIG. 2 (e.g., the user device 100, the infrastructure orchestrator 102, the infrastructure agent A 108, the infrastructure agent B 110, the infrastructure resources A 112, the infrastructure resources B 114 of FIG. 1, the infrastructure orchestrator 200 of FIG. 2) may be implemented, at least in part, using one or more computing devices, and all or any portion of the methods and examples shown in FIG. 3 and FIG. 4 may be performed using one or more computing devices, such as the computing device 500.

The computing device 500 may include one or more computer processors 502, non-persistent storage 504 (e.g., volatile memory, such as random access memory (RAM), cache memory), persistent storage 506 (e.g., a hard disk, an optical drive such as a compact disk (CD) drive or digital versatile disk (DVD) drive, a flash memory), a communication interface 512 (e.g., Bluetooth interface, infrared interface, network interface, optical interface), input devices 510, output devices 508, and numerous other elements (not shown) and functionalities. Each of these components is described below.

In one or more examples, the computer processor(s) 502 may be an integrated circuit for processing instructions. For example, the computer processor(s) may be one or more cores or micro-cores of a processor. The processor 502 may be a general-purpose processor configured to execute program code included in software executing on the computing device 500. The processor 502 may be a special purpose processor where certain instructions are incorporated into the processor design. The processor 502 may be an application specific integrated circuit (ASIC), a graphics processing unit (GPU), a data processing unit (DPU), a tensor processing units (TPU), an associative processing unit (APU), a vision processing units (VPU), a quantum processing units (QPU), and/or various other processing units that use special purpose hardware (e.g., field programmable gate arrays (FPGAs), System-on-a-Chips (SOCs), digital signal processors (DSPs), and the like. Although only one processor 502 is shown in FIG. 5, the computing device 500 may include any number of processors without departing from the scope of examples disclosed herein.

The computing device 500 may also include one or more input devices 510, such as a touchscreen, keyboard, mouse, microphone, touchpad, electronic pen, motion sensor, or any other type of input device. The input devices 510 may allow a user to interact with the computing device 500. In one or more examples, the computing device 500 may include one or more output devices 508, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing devices exist, and the aforementioned input and output device(s) may take other forms. In some instances, multimodal systems can allow a user to provide multiple types of input/output to communicate with the computing device 500.

Further, the communication interface 512 may facilitate connecting the computing device 500 to a network (not shown) (e.g., a local area network (LAN), a wide area network (WAN) such as the Internet, mobile network, or any other type of network) and/or to another device, such as another computing device. The communication interface 512 may perform or facilitate receipt and/or transmission of wired or wireless communications using wired and/or wireless transceivers of any type and/or technology. Examples include, but are not limited to, those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 512 may also include one or more Global Navigation Satellite System (GNSS) receivers or transceivers that are used to determine a location of the computing device 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable means including memory sharing, message passing, token passing, network transmission, or the like.

All or any portion of the components of the computing device 500 may be implemented in circuitry. For example, the components can include and/or can be implemented using electronic circuits or other electronic hardware, which can include one or more programmable electronic circuits (e.g., microprocessors, GPUs, DSPs, FPGAs, CPUs, and/or other suitable electronic circuits), and/or can include and/or be implemented using computer software, firmware, or any combination thereof, to perform the various operations described herein. In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples of examples described herein. It will be understood by those skilled in the art (who also have the benefit of this disclosure) that one or more examples described herein may be practiced without these specific details, and that numerous variations or modifications may be possible without departing from the scope of the examples described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects of examples disclosed herein.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not included in a figure. A process may correspond to a method, a function, a procedure, a subroutine, a subprogram, and the like. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, and the like. Examples of computer-readable media that may be used to store instructions, information used, and/or information created during methods according to described examples include magnetic or optical disks, flash memory, USB devices provided with non-volatile memory, networked storage devices, and so on.

In the above description of the figures, any component described with regard to a figure, in various examples described herein, may be equivalent to one or more same or similarly named and/or numbered components described with regard to any other figure. For brevity, descriptions of these components may not be repeated with regard to each figure. Thus, each and every example of the components of each figure is incorporated by reference and assumed to be optionally present within every other figure having one or more same or similarly named and/or numbered components. Additionally, in accordance with various examples described herein, any description of the components of a figure is to be interpreted as an optional example, which may be implemented in addition to, in conjunction with, or in place of the examples described with regard to a corresponding one or more same or similarly named and/or numbered component in any other figure.

Throughout the application, ordinal numbers (e.g., first, second, third) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While examples discussed herein have been described with respect to a limited number of examples, those skilled in the art, having the benefit of this disclosure, will appreciate that other examples can be devised which do not depart from the scope of examples as disclosed herein. Accordingly, the scope of examples described herein should be limited only by the attached claims.

What is claimed is:

1. A system, comprising:
one or more processors; and
one or more non-transitory computer readable media storing instructions which, when executed by the one or more processors, cause the one or more processors to:
receive a template request, at an infrastructure orchestrator, for a workload environment in an infrastructure as a service (IaaS) environment;
obtain, by the infrastructure orchestrator, an infrastructure group template corresponding to the workload environment specified in the template request;
provide, by the infrastructure orchestrator and to a user device, the infrastructure group template, wherein the user device updates the infrastructure group template to obtain an updated infrastructure group template;
receive, at the infrastructure orchestrator, an infrastructure group configuration request comprising the updated infrastructure group template;
provide, from the infrastructure orchestrator and to an infrastructure agent executing at an infrastructure site, an instruction to deploy an infrastructure group corresponding to the updated infrastructure group template, wherein the infrastructure agent initiates a deployment of the infrastructure group at the infrastructure site based on the infrastructure group template; and
provide, by the infrastructure agent and to the user device, a status response corresponding to the deployment of the infrastructure group, wherein the status response indicates whether the deployment was a success or a failure.

2. The system of claim 1, wherein the execution of the instructions further causes the one or more processors to:
perform a validation of the infrastructure group template before providing the instruction to deploy the infrastructure group to the infrastructure agent.

3. The system of claim 2, wherein when the validation is a validation failure, an indication of the validation failure is provided to the user device that comprises a reason for the failure of the validation.

4. The system of claim 1, wherein the infrastructure site is specified in the update infrastructure group template.

5. The system of claim 1, wherein the infrastructure agent initiates the deployment of the infrastructure group using infrastructure resources of the infrastructure site.

6. The system of claim 1, wherein the template request specifies a virtualization environment for deploying a plurality of virtual machines, a container environment for deploying a plurality of containers, or a plurality of nodes for implementing a high performance computing (HPC) cluster.

7. The system of claim 1, wherein the infrastructure group template comprises configuration details for compute resources, storage resources, and network resources.

8. A computer-implemented method, comprising:
receiving a template request, at an infrastructure orchestrator, for a workload environment in an infrastructure as a service (IaaS) environment;
obtaining, by the infrastructure orchestrator, an infrastructure group template corresponding to the workload environment specified in the template request;
providing, by the infrastructure orchestrator and to a user device, the infrastructure group template, wherein the user device updates the infrastructure group template to obtain an updated infrastructure group template;
receiving, at the infrastructure orchestrator, an infrastructure group configuration request comprising the updated infrastructure group template;
providing, from the infrastructure orchestrator and to an infrastructure agent executing at an infrastructure site, an instruction to deploy an infrastructure group corresponding to the updated infrastructure group template, wherein the infrastructure agent initiates a deployment of the infrastructure group at the infrastructure site based on the infrastructure group template; and
providing, by the infrastructure agent and to the user device, a status response corresponding to the deployment of the infrastructure group, wherein the status response indicates whether the deployment was a success or a failure.

9. The computer-implemented method of claim 8, further comprising:
performing a validation of the infrastructure group template before providing the instruction to deploy the infrastructure group to the infrastructure agent.

10. The computer-implemented method of claim 9, wherein when the validation is a validation failure, an indication of the validation failure is provided to the user device that comprises a reason for the failure of the validation.

11. The computer-implemented method of claim 8, wherein the infrastructure site is specified in the update infrastructure group template.

12. The computer-implemented method of claim 8, wherein the infrastructure agent initiates the deployment of the infrastructure group using infrastructure resources of the infrastructure site.

13. The computer-implemented method of claim 8, wherein the template request specifies a virtualization environment for deploying a plurality of virtual machines, a container environment for deploying a plurality of containers, or a plurality of nodes for implementing a high performance computing (HPC) cluster.

14. The computer-implemented method of claim 8, wherein the infrastructure group template comprises configuration details for compute resources, storage resources, and network resources.

15. A non-transitory computer-readable medium storing programming for execution by one or more processors, the programming comprising instructions to:
receive a template request, at an infrastructure orchestrator, for a workload environment in an infrastructure as a service (IaaS) environment;
obtain, by the infrastructure orchestrator, an infrastructure group template corresponding to the workload environment specified in the template request;
provide, by the infrastructure orchestrator and to a user device, the infrastructure group template, wherein the user device updates the infrastructure group template to obtain an updated infrastructure group template;
receive, at the infrastructure orchestrator, an infrastructure group configuration request comprising the updated infrastructure group template;
provide, from the infrastructure orchestrator and to an infrastructure agent executing at an infrastructure site, an instruction to deploy an infrastructure group corresponding to the updated infrastructure group template, wherein the infrastructure agent initiates a deployment of the infrastructure group at the infrastructure site based on the infrastructure group template; and
provide, by the infrastructure agent and to the user device, a status response corresponding to the deployment of the infrastructure group, wherein the status response indicates whether the deployment was a success or a failure.

16. The non-transitory computer-readable medium of claim 15, wherein the programming comprises further instructions to:
perform a validation of the infrastructure group template before providing the instruction to deploy the infrastructure group to the infrastructure agent.

17. The non-transitory computer-readable medium of claim 16, wherein when the validation is a validation failure, an indication of the validation failure is provided to the user device that comprises a reason for the failure of the validation.

18. The non-transitory computer-readable medium of claim 15, wherein the infrastructure site is specified in the update infrastructure group template.

19. The non-transitory computer-readable medium of claim 15, wherein the template request specifies a virtualization environment for deploying a plurality of virtual machines, a container environment for deploying a plurality of containers, or a plurality of nodes for implementing a high performance computing (HPC) cluster.

20. The non-transitory computer-readable medium of claim 15, wherein the infrastructure group template comprises configuration details for compute resources, storage resources, and network resources.
